(19) United States
(12) Patent Application Publication
(10) Pub. No.: US 2011/0061497 A1
(43) Pub. Date: Mar. 17, 2011

(54) Jar opener

(76) Inventors: Tadeusz-Zygmunt Jedrzejewski, Scarborough (CA); Grzegorz-Cezary Jedrzejewski, Minesing (CA)

(21) Appl. No.: 12/585,406

(22) Filed: Sep. 15, 2009

(51) Int. Cl. B67B 7/18

(52) U.S. Cl. 81/3.4

(57) ABSTRACT

An immobilization device to grip the threaded closure/cap of a container has spring-driven cam-actuated jaws to grip a full range of sizes of closures/caps, with raked gripping teeth that permit free-wheel rotation of a closure/cap within the jaws. On reversal of rotation, the teeth grip the closure/cap. One embodiment has blades each with a projecting toe that holds the closure/cap. Two forms of latch are available, one providing enhanced gripping of the closure/cap; the second providing automatic operation of the closure jaws. Shock absorbers protect the mechanism against damaging impacts resulting from uncontrolled action of the return spring.

### BACKGROUND OF THE INVENTION

1. This invention is directed to a jar opener, and in particular to an immobilization apparatus for immobilizing a threaded closure/cap on a container, to facilitate relative rotation between the container and the closure/cap, by immobilization of the closure cap, followed by rotation of the container by the user, in order to ‘break’ the existing tight seal, for removal of the closure/cap by the user.

2. In many instances, an undue degree of torque effort is required in order to “break” the seal of a screwed closure/cap applied to an evacuated container, such effort being beyond the limit of physical strength of many, particularly the elderly. There presently exist a great many cap immobilization devices provided to assist this need. These prior devices have much in common with the apparatus of the present invention, including jar openers mounted on the undersurface of a cabinet, having adjustable jaws for entry of jar closure/caps in a range of sizes, between the jaws. However, these prior arrangements are hindered by a number of factors, such as a inadequate gripping capability and a degree of inflexibility, which detract from the optimum assistance that should be available to a user, in being enabled to apply their maximum efforts in opening such containers.

### BRIEF SUMMARY OF THE INVENTION

The present invention of a closure/cap gripping device is directed primarily to apparatus to receive the closure/cap of a container in immobilized relation, to assist a user in the rotational, unscrewing detachment of the attached container from its immobilized closure/cap.

It will be understood that some closure caps have a continuous, generally right-handed thread form, while the thread form of many such closure/caps is discontinuous, and require only a partial revolution in order to unseal and disengage.

In a preferred embodiment, the subject apparatus is used in an immobilization role, being mounted beneath a support surface, such as a kitchen counter or cupboard in order to receive entry of a subject closure/cap, with the related container held in an upright condition beneath, so as to leave the contents of the container substantially undisturbed during the unscrewing and downward removal of the container from the immobilized closure/cap.

Closure/caps presently in common use vary in diameter between one and three quarter inches to three and five sixteenths inches.

The cap/closure gripping apparatus of the present invention has an outer face plate rotatably mounted on a fixed cam plate that contains three recessed curved cam slots, in mutually spaced relation. The face plate has three inwardly directed tracks, each containing a sliding jaw with a projecting tooth to make gripping contact with the closure/cap of a container. A cam pin projecting from each jaw extends through a slot in the face plate and is entered in slidable engagement with a respective cam slot in the cam plate.

A handle projecting outwardly from the face plate enables selective rotation of the face plate, to actuate the jaws. The handle functions, relative to the fixed cam plate in an ‘opening’ or in a ‘closing’ sense, thereby displacing the sliding jaws outwardly or inwardly in accordance with the direction of rotation of the handle.

Rotation of the face plate in an opening sense, by way of its handle moves the cam pins along their respective slots, and causes the jaws to slide outwardly along their respective tracks, to a fully open position, enabling the upward insertion of the container's closure/cap within the jaws.

The gripping device may include a return spring that interconnects the face plate with the cam plate, and which produces reverse rotation of the face plate on release of the handle, causing the jaws to slide inwardly along their tracks, to engage the inserted closure/cap.

In one embodiment a toothed rack and ratchet serve as a latch to engage the outer face plate with the underlying fixed cam plate, to immobilize the face plate. The latch is disengaged to free the face plate, by operation of a latch release pin that extends between the jaws of the face plate, and is actuated by the insertion of a closure cap within the jaws.

In this or a further embodiment, the face plate handle may include a pivoted toothed lever, which can engage an arcuate toothed rack of the cam plate, located adjacent the edge of the face plate. The toothed lever can be actuated to serve as a latch, to immobilize the face plate. Further displacement of the toothed lever can be used to apply a positive closure force to the jaws of the device, with consequent tightened gripping of the inserted closure/cap by the jaws.

The jaw teeth that contact the closure cap project substantially normally to the jaws and are shaped such that the closure cap can be substantially freely rotated within the teeth, in a “tightening direction” for a right-hand thread. This enables selective rotation of the associated container about its polar (vertical) axis, to a user-preferred orientation for applying maximum opening force to the container.

Application of force to the container in the reverse (opening) direction fully engages the jaw teeth with the closure/cap, enabling the seal to be ‘broken’ and the closure cap to be unscrewed from its container.

The travel of the jaws is synchronized and controlled by the fixed cam plate, concealed behind the face plate of the device.

The curved cam tracks are located such that the reaction forces acting on the jaws and their cam pins during operation of the device are applied substantially normal to the outer walls of the cam grooves, so that the jaws are immobilized with little tendency to ‘overhaul’ by displacement of their followers along the cam track when under load.

The extent of the spiral of the cam tracks determines the range of jaw travel, and the range of sizes of closures/caps that can be accommodated within the jaws.

In operation of the device, with the jaws moved to their fully open position, when the face plate is freed to move, by release of one or other of the latches, or by release of the handle, the return spring rotates the face plate, causing the jaws to close. This brings the jaws into engagement with an inserted closure/cap and takes up any clearances or ‘slack’ in the apparatus, including backlash and clearances of the cam followers within the cam grooves, so as to apply a steady pressure of the jaw teeth against the inserted closure/cap.

In use, the handle is moved to open the jaws, for insertion of the closure/cap upwardly between the jaws, and the handle then released, and reversed by the return spring to bring the jaws into contact with the inserted closure/cap.

The latch provisions include an arcuate toothed rack that is mounted on or behind the cam plate, being engaged by a pivotal, toothed latch member carried by the outer face plate. Rotation of the handle in a ‘jaws-open’ direction draws the latch across the teeth of the rack. At termination of arm displacement the latch pivots into engagement with a tooth of the rack, linking the face plate to the cam plate, to hold the jaws open to accept the insertion of a closure/cap.

A latch release pin projects upwardly through the face plate, being located between the jaws, and is actuated by being displaced by the top of a closure cap, on its insertion. The insertion of the closure/cap within the jaws displaces the latch release pin, which causes the opening of the latch, which in turn releases the face plate and the jaw assembly for rotation by the spring, to bring the jaw teeth into gripping contact with the closure/cap.

The three jaws centre the closure cap within the jaws.

In the case of a jar opener embodiment that relies solely upon spring actuation it has been determined that for adequate gripping force at the jaws to open a small closure/cap of 1¾ inch diameter, each jaw is required to apply a radial force of 968 grams to ensure adequate gripping of the closure/cap by the teeth.

In the case of the largest size closure/cap (of 3 5/16 inch diameter) the required radial force per jaw is 1404 grams.

Opening of the jaws automatically increases the spring tension.

Certain of the foregoing aspects of the present invention in regard to the provision of cam-track actuated jaws may be found in the related prior art.

Each of the jaws has a downwardly projecting tooth that makes contact with the skirt of the closure/cap. Each tooth has a leading edge, that makes initial contact with the skirt portion of the closure/cap. The trailing edge of the tooth is slightly relieved, such that it does not make contact with the closure/cap, being located anti-clockwise from the leading edge, when viewed from beneath.

Thus, a container with its closure/cap inserted within the closed jaws may be rotated anti-clockwise comparatively freely, with the contact edges of the teeth failing to engage the closure cap. This may be referred to as a “freewheeling” action.

However, reversal of the rotation of the container and its closure/cap to a clockwise direction then brings the leading (contact) edges of the teeth into jamming, immobilizing engagement with the closure/cap. Continued application of a clockwise torque to the associated container can then result in the ‘breaking’ of the seal between closure/cap and its container. With the seal thus ‘broken’, continued clockwise rotation of the container serves to complete the unscrewing of the container from its closure/cap.

Utilizing the free-wheel capability of the gripping device, once the seal is broken, the container may in some instances be rotatably oscillated to and fro by the user, in a ratcheting action, to complete the removal of the closure cap, thereby enabling a user to maintain a two-handed grasp on the container, until it is freed from its closure/cap. Alternatively, once the seal is broken, the jaws may be opened by use of the spring-loaded handle, thereby freeing the closure/cap from the grip of the jaws and permitting downward withdrawal of the container and its still attached closure/cap from the gripping apparatus. Final removal of the cap from the container may then be completed manually.

The teeth of the gripping apparatus may be slightly outwardly inclined, in a downward direction to provide a slight ‘coning’ effect, such that maximum contact between the teeth and the closure/cap occurs at the top of the closure/cap, adjacent its top surface or ‘dome’, the zone of greatest structural rigidity of the closure/cap, and the preferred point for applying load. This coning angle (referred to below as the “beta” angle) has a preferred, limited range of values, as there is a tendency for the closing force applied by the jaws to expel the closure/cap axially downwardly within the cone of the teeth.

The beta angle (the angle of coning) is the angle of deviance of the coned tooth from extending at right angles (i.e. “normal”) to the jaws.

Another embodiment provides gripper teeth, each tooth having an inwardly extending toe portion that projects beneath the bottom edge of the skirt of the closure/cap when the jaws are closed, the toe serving to retain the cap in engagement with the jaws, so that the container may be fully unscrewed downwardly, and freed from its closure/cap, for downward removal of the container, while enabling two-handed support by the user.

The present invention thus provides a jar opener, to immobilize the closure/cap of a sealed container, to facilitate removal by a user of the closure/cap from the container; the jar opener having a closure/cap gripping device with a rotatable face plate; at least three jaw guides located in mutually converging relation on the face plate; at least three gripper jaws movably mounted in respective ones of the jaw guides; each gripper jaw having an inclined protruding gripper tooth; each tooth having a contact face for contacting side portions of the closure/cap; the jar opener having a synchronizing device for selectively moving the gripper jaws along the jaw guides in mutually synchronized displaced relation relative to the closure/cap, to bring the at least three gripper teeth into contacting relation with the side of the closure cap; the gripper teeth having an inner contact face to contact the closure/cap side; the contact face having a leading edge to make gripping contact with the closure/cap side, and a trailing edge in relieved relation from the closure cap side, whereby in use, rotation of the closure/cap in a first direction away from the leading edge permits freewheeling rotation of the closure cap in non-gripping relation past the trailing edge, and rotation in a second, reversed direction brings the teeth leading edges into gripping, immobilizing relation with the closure/cap, to facilitate removal of the closure/cap by the user.

In a preferred embodiment the trailing edges of the gripper teeth contact faces of the subject jar opener have an angle of relief of 10-degrees from the leading edges; the teeth having a cone angle of minus six degrees; with the teeth being upset at 90 degrees from the gripper jaws (i.e. zero deviance); and the synchronizing device having three inwardly spiraling cam tracks, each connected in controlling relation with a respective gripper jaw by way of a cam track follower pin; the cam tracks being inwardly inclined at 18-degrees from tangential, whereby rotational displacement of the cam tracks by substantially 115 degrees will produce displacement of the gripper jaws from gripping a small closure cap of 1¾ inch diameter to gripping a large closure cap of 3 5/16 inch diameter.

The subject synchronizing device includes a control arm secured to the face plate, in rotational control thereof; a return spring connected in return controlling relation with the face plate, to effect displacement of the gripper jaws inwardly into contacting relation with the closure cap; and a fixed cam plate having a plurality of cam track recesses to receive cam follower portions of the jaws in entered relation with the track recesses; whereby rotation of the control arm in a first direction draws the follower portions along the cam tracks and extends the jaws in mutual opening relation, to permit insertion of a closure/cap in entered relation between the jaws. Subsequent rotation of the arm in that first direction also enables release of the device during removal of the container from the closure/cap. Rotation of the control arm in a second, reversed direction moves the jaws in mutually converging relation.

The jaw teeth are mutually divergently inclined upon the jaws, in use to form a slightly convergent entry between the teeth for the insertion of a closure/cap.

One particular advantage of the capability to ‘freewheel’ the cap within the jaws is that a user can continue supporting the container with both hands, while reorienting it about its polar axis to a desired orientation.

In the case of asymmetrically shaped containers, this freewheeling aspect of the gripper device enables the container to be readily rotated into a preferred, selected gripping position, with the container oriented to the user's preference, so that upon reversing the direction of rotation so that the teeth grip the closure/cap, the user can then apply their maximum opening force in rotating the container, to undo the closure/cap.

It will be understood that the foregoing description is directed to a gripping device for use in removing (regular) right-hand-threaded closure/caps.

The reversal of the manufactured blade edge relief to the opposite edge of the blade would result in a gripping device for use with closure/caps having a left-hand threading.

It will also be understood that the structural gripping characteristics of the present invention may also be applied to a portable device for gripping closures/caps.

In constructing the jaw/tooth combination there are three significant angles that may be subject to variance, by design or by manufacturing tolerances.

The first, referred to as the ‘gamma’ angle is the deviance from 90 degrees, of the upset tooth from the plane of the jaw; the second, the ‘beta’ angle, is the inclination from vertical of the teeth which provides the “entry cone” effect; and the third, the ‘alpha’ angle, is the degree of relief of the tooth contact surface that enables the unhindered (clockwise), freewheeling rotation of a closure/cap within the gripper teeth.

A tabulation of these values is given below.

The incorporation of a shock absorber for the mechanism prevents destructive impact of the moving parts of the opening mechanism in the event that the arm is released under full spring tension, at the ‘fully-open’ position, so as to accelerate the jaws to an impact velocity. This shock absorber may comprise a stiff fibrous insert located at the inner ends of the cam grooves, to be impacted by the follower pins. at the end of their travel; or an equivalent impact absorber located at the inner ends of the jaw guides, for the same cushioning, shock absorbing effect.

It will be understood that embodiments incorporating the disclosed tooth characteristics need not necessarily include one or other of the latches, or the return spring, each of which may form the basis of separate embodiments.

### BRIEF DESCRIPTION OF THE SEVERAL VIEWS OF THE DRAWING

Certain embodiments of the invention are illustrated, by way of example, without limitation of the invention thereto, other than as set forth in the accompanying claims; it being understood that further embodiments may be derived by one skilled in the art. Reference is made to the accompanying drawings, wherein:

FIG. 1 shows a perspective view of an inverted gripper device in accordance with the present invention;

FIG. 2 is an enlarged perspective view of a gripper jaw and blade from FIG. 1;

FIG. 3 is a view similar to FIG. 2, for a jaw and blade incorporating a retention toe;

FIG. 4 is a plan view from above of a cam plate portion of the subject gripper device (FIG. 6 embodiment), taken in its installed orientation;

FIG. 5 is a perspective view of portions of the subject gripper device installed beneath a kitchen cupboard;

FIG. 6 is a perspective plan view from above the subject cam plate (taken in its installed orientation), having a return spring assembly mounted thereon;

FIG. 7 is a perspective view of a further embodiment of an inverted gripper device in accordance with the present invention, having a peripheral latch;

FIG. 8 is a perspective plan view from above the cam plate of FIG. 4, showing a second latch mechanism; and,

FIG. 9 is a side cross-section view taken on the lines 9-9 of FIG. 8.

### DETAILED DESCRIPTION OF THE INVENTION

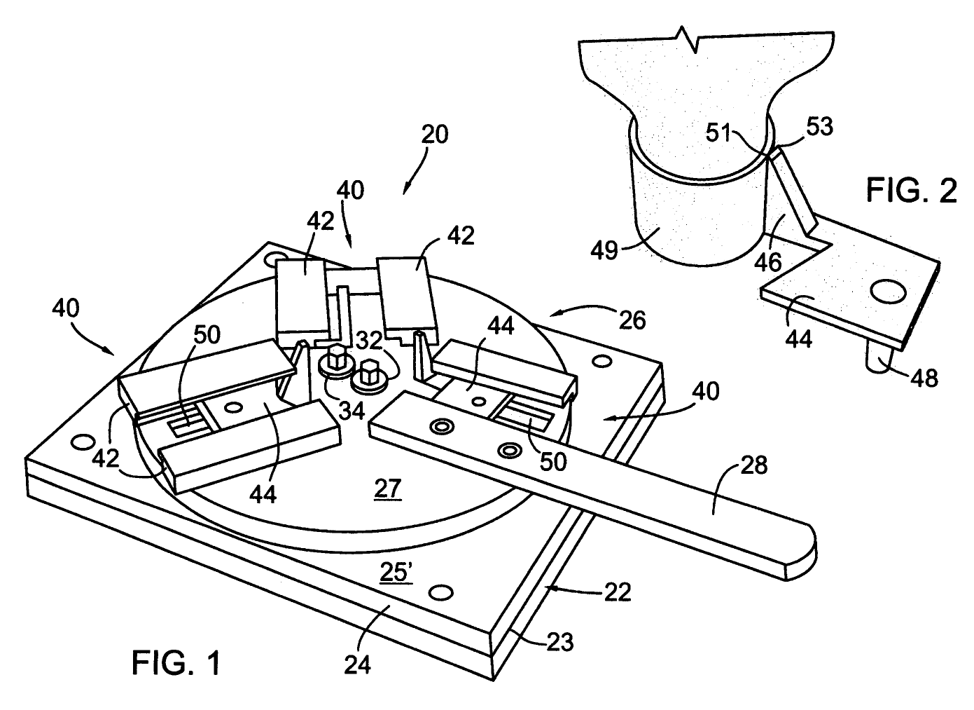

Referring to the drawings, in FIG. 1 the gripper device 20 is shown inverted, for ease of reference.

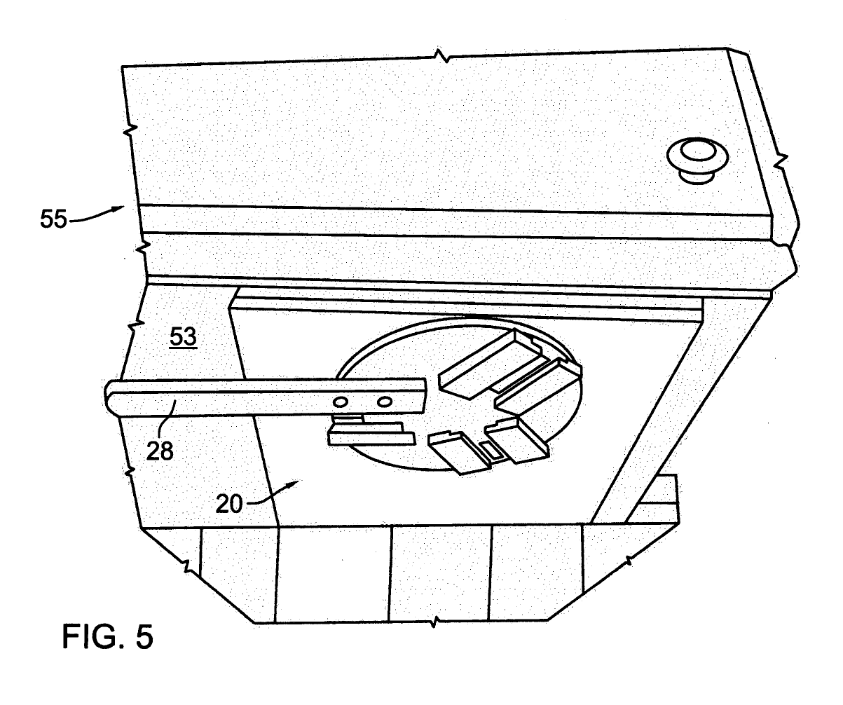

To avoid confusion, in view of the fact that the device 20 is normally used, secured to the underside of a cabinet or a countertop (see FIG. 5), the terms Proximal (meaning nearer), and Distal, meaning more remote will be used.

A base plate 22 has attached to its proximal face 23 a cam plate 24, upon the proximal face 25 of which a face plate 27 with gripper assembly 26 is rotatably mounted.

A projecting arm 28 is attached to the proximal face plate 27 of gripper assembly 26, to facilitate its rotation.

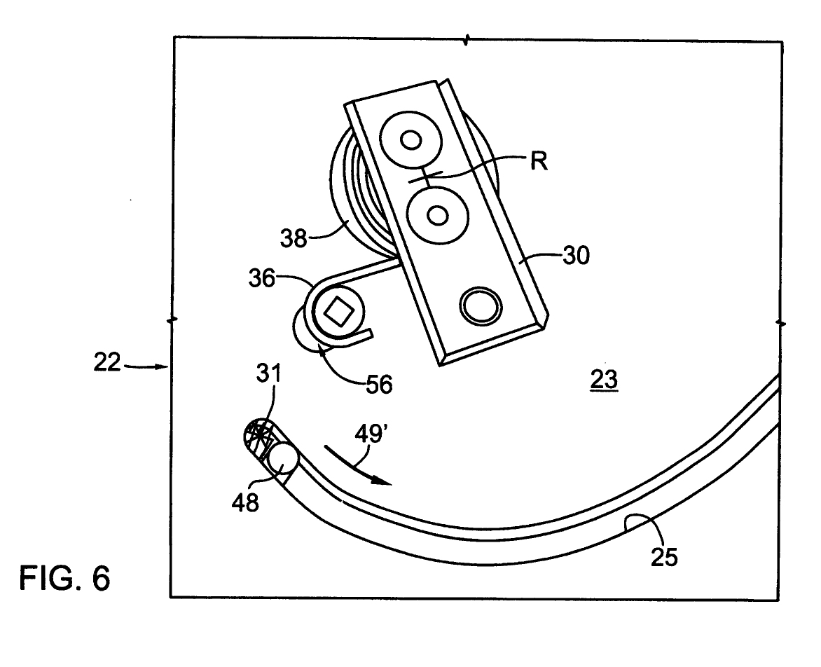

A coil spring housing 30 (see FIGS. 6 & 8), located within a recess in the base plate 22 is connected through the cam plate 24 to the gripper assembly 26, by way of pin 32 so that the spring housing 30 also rotates with the gripper assembly 26 when the arm 28 is rotated. The end 36 of the coil spring 38 is secured to the cam plate 22, being attached to a stud 56 that projects from cam plate 22, so that rotational displacement of the gripper assembly 26 changes the tension in the spring 38.

Three guideways 40, illustrated as extending radially of the gripper assembly 26, each comprise a pair of opposed recessed slide guides 42. Within each guideway 40 is slidably mounted a gripper jaw 44, on the radially inner end of which jaw 44 is a projecting tooth 46 that extends downwardly in operation. Beneath each gripper jaw 44 there extends a cam follower pin 48, that extends through a slot 50 in face plate 27, and projects beyond the distal face of face plate 27, to engage cam slots 25 (FIGS. 4 and 6) that are illustrated as extending through the cam plate 24. It will be understood that the cam slots 25 may be recessed into the surface of cam plate 24. Referring to FIG. 2, each gripper jaw 44 has a (downwardly) projecting tooth 46, the radially inner front face of which makes contact with the closure/cap 49.

The leading tooth edge 51 makes gripping contact with the closure/cap 49, while the trailing edge 53 is relieved and does not make contact with the closure/cap 49.

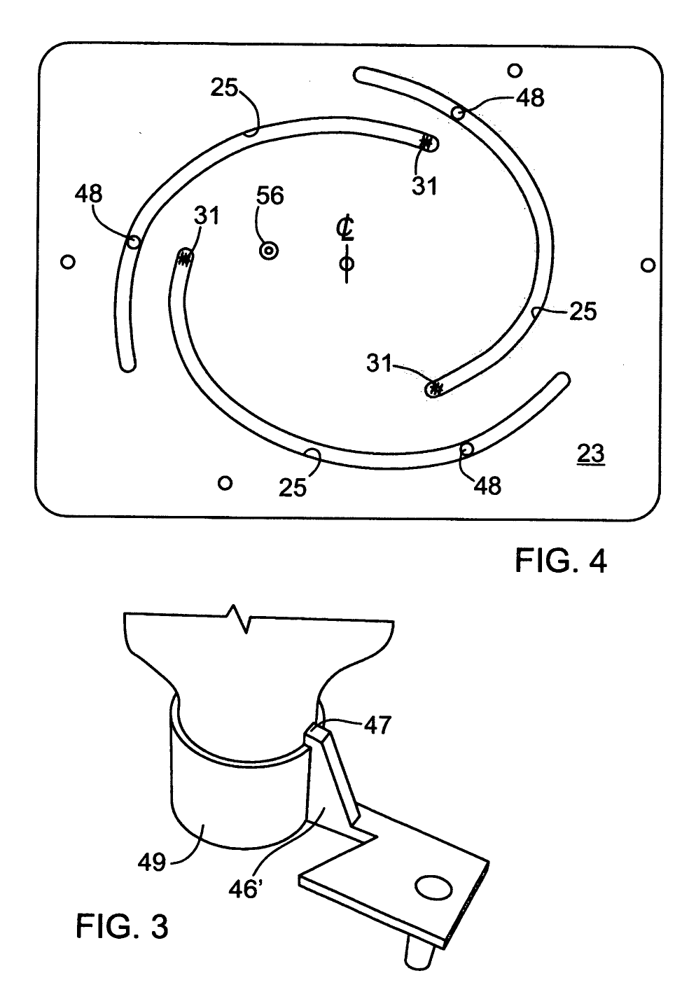

Referring to the FIG. 3 tooth embodiment, the tooth 46′ has a forwardly projecting toe portion 47 that can enter beneath the bottom edge of the closure/cap 49, so that the teeth of the three jaws can retain the closure cap secured to the gripper assembly 26, where it is retained during the unscrewing and downward removal of the container from its closure/cap. Subsequently the arm 28 can be actuated to open the jaws 44 of the gripper assembly 26, to release the closure/cap 49.

A toe portion 47, extending about 1/16 of an inch, is effective in its closure/cap skirt engagement function, while avoiding contact with the container surface. Referring to FIG. 4, the cam plate 24 has three curved cam tracks 25, with three follower pins 48 positioned at an intermediate location of jaw opening. At the innermost ends of the tracks 25 are shown shock absorber masses 31. This cam plate 24 is for use with the embodiment further illustrated in FIG. 6.

Referring to FIG. 5, elements of the gripper device 20 are shown attached to the underside 53 of a kitchen cupboard 55. This illustrated orientation of the gripper device 20 is its working position, so that containers (not shown) with closure/caps 49 can be inserted upwardly into the device 20, so that the jaws (not shown) enclose the closure/cap 49.

Turning to FIG. 6, the cam plate 22 has three cam slots 25 recessed through it to receive the respective cam followers 48 into their respective cam slots 25, when the device is assembled. The top of a follower 48 is shown, extending up from the underlying gripper device 20 (not shown).

Referring also to FIG. 6, the coil spring housing 30 is located above the upper (when installed) face of the cam plate 22 (which is the underside, in the inverted view of FIG. 1), being centred on the axis of rotation R of the assembly 26.

The end hook portion 36 of the coil spring 38 is hooked on to a stud 56 that projects from the proximal face 23 of cam plate 22. The cam follower 48 is illustrated at the end of its travel, with the jaws 44 at their innermost (closed) position. The upper end of a cam follower 48 is shown in cam slot 25, located in the ‘jaws closed’ position, abutting a shock absorber fibrous mass 31.

In use, the arm 28 is rotated counter-clockwise (the FIG. 1 illustrated position being inverted, showing as clockwise), drawing the cam follower pins 48 along the respective cam slot 25 in the direction of the arrow 49′, to open the jaws 44, while tensioning the spring 38.

The container that is to be opened is raised beneath the device 20 so as to position its closure/cap 49 in entered relation between the three jaws 44. The arm 28 is then released, permitting the spring 38 to reverse the gripper assembly 26 and move the jaws 44 inwardly, to center and secure the closure cap 49, bringing the leading tooth edges 51 into contact with the sides of closure/cap 49.

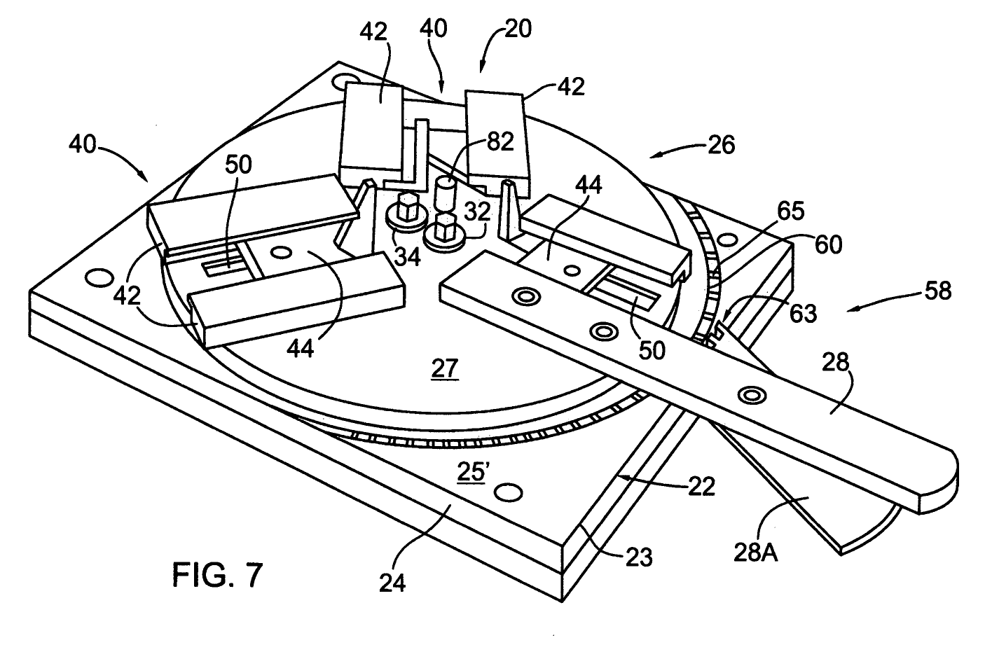

In this condition, the orientation of the container, relative to the user may be changed by counter-clockwise rotation of the container into its desired orientation (see FIG. 2). During this reorientation displacement, the surface of the closure/cap can slide comparatively freely past the tooth 46, in a freewheeling motion. However, upon reversal of the rotation of the container to a clockwise rotation, the now leading edge 51 of the tooth 46 engages and grips the closure/cap, terminating its rotational movement. The user can then apply both hands to the container, to exert a high, clockwise torque against the container and the immobilized closure/cap, which torque normally serves to “break” the seal between closure/cap and container. Continued rotation of the container serves to fully unscrew the closure/cap, and releases the container from the gripper device 20. Turning to FIG. 7, a first latch mechanism 58 has an arcuate toothed rack 60 projecting from the proximal face 25′ of cam plate 24. A lever 28A is pivotally secured at 61 to the upper side of the arm 28 (illustrated in an inverted position). The arcuate inner end face of lever 28A has gear teeth 63 along its edge that can be pivoted into engagement with the toothed rack 60. A friction washer (not shown) interposed between lever 28A and the arm 28 serves as a brake against undesired pivoting of the lever 28A, while permitting ready manual positioning of the lever 28A.

The gear rack 60 is radially spaced from the gripper assembly 26. The inclined teeth 63 of lever 28A mesh with the teeth 65 of the rack 60 when lever 28A is pivoted, to bring the teeth 63, 65 into latching engagement, thereby locking the arm 28.

In use, with the arm 28 in a desired position, the lever 28A can be manually displaced, to bring its teeth 63 into engagement with the rack teeth 65, thereby latching the arm 28 in that position, and setting the jaws 44 accordingly.

Release of the latched arm 28 by disengagement of the teeth 65 from the rack teeth 63 permits the arm to rotate, bringing the jaw teeth 46 into engagement with the closure/cap. The lever 28A can then be brought into re-engagement with the rack 60, and then further pivoted so as to apply loading torque against the arm 28, thereby applying further compressive gripping force to the teeth 46 of the gripper assembly 26 and optimizing conditions for the removal of an unduly tight closure/cap.

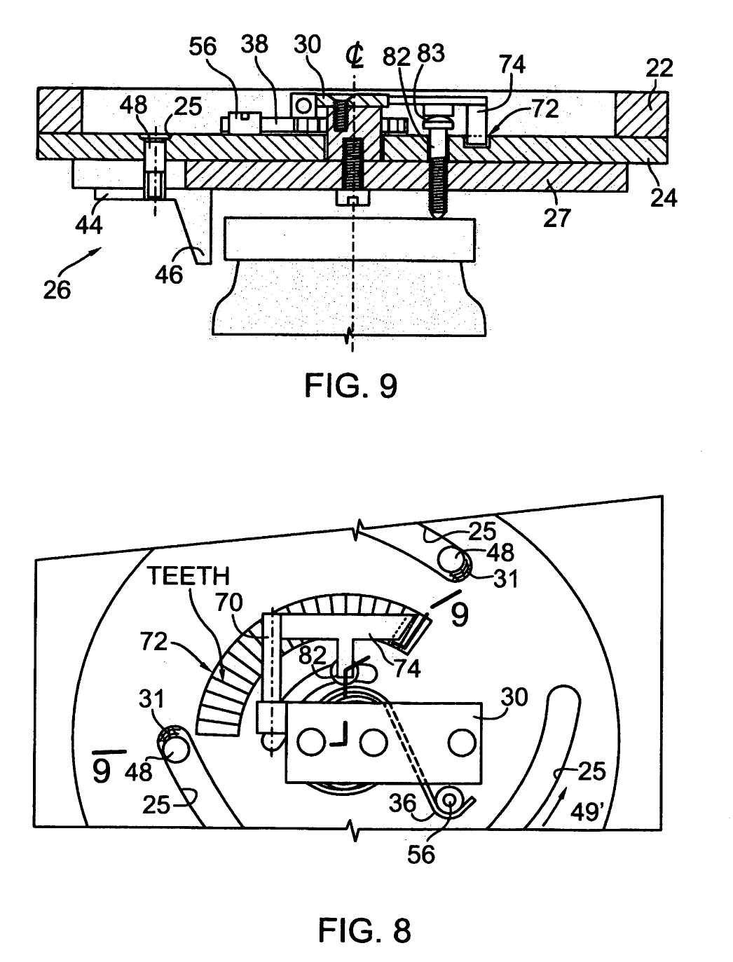

The location of the trip release 82 of a second latch 70 that is illustrated in FIGS. 8 and 9, is shown in relation to the jaws 44 of gripper assembly 26.

Turning to FIGS. 8 and 9, a second latch 70 is located on the upper face of the cam plate 24. The second latch 70 has an arcuate toothed rack 72 recessed into the face of cam plate 24. The latch ratchet 74 is pivotally supported at one end on shaft 78 that is journalled in spring housing 30.

The self-weight of ratchet 74 presses it downwardly onto the teeth of rack 72.

A trip release 82 extends through the face plate 27 (see FIG. 7), having an enlarged head portion 83. The upward displacement of release head portion 83 by the insertion of a closure/cap against the release 82 disengages the ratchet 74. This disengagement of ratchet 74 allows the spring 38 of to rotate gripper assembly 26, bringing the teeth 46 of jaws 44 into engagement with the closure/cap 49.

The location of trip release 82 in relation to gripper assembly 26 is shown in FIG. 7. The trip release 82 of the second latch 70 is located between the teeth 46 of the gripper assembly 26, so as to be actuated by the insertion of a closure/cap 49 into the gripper assembly 26.

It should be noted that the base plate and the cam plate may be combined as a single plate.

TABLE 1
[alpha, beta and gamma angular settings that have tested
as being operable (the alpha angle is that of blade rear edge
relief from being at rightangles to the leading edge); the
beta angle is the angle of ‘coning’ of the blade from
the zero-cone setting; the gamma angle is the deviance from
a ‘normal’ blade (90 degree upset angle)]

| Setting | Alpha | Beta | Gamma | Grip to open | Slip to Reverse |
|---|---|---|---|---|---|
| 1 | 10 | −10 | 0 | yes | yes |
| 2 | 10 | −8 | 0 | yes | yes |
| 3 | 10 | −6 | −10 | yes | yes |

TABLE 2
[effect of cam track inclination from tangent
on angular track extent (for full jaw travel)]

| SPIRAL TRACK SLOPE | |
|---|---|
| (DEGREES FROM TANGENT) | TRACK EXTENT (DEGREES) |
| 10 | 275 |
| 12 | 220 |
| 14 | 175 |
| 16 | 140 |
| 18 | 115 |
| 20 | 105 |
| 22 | 95 |

TABLE 3
[variance effects in tooth geometry - alpha, beta and gamma angular settings]

| | Blade edge relief | Cone angle | Blade upset angle | Track | Axial | |
|---|---|---|---|---|---|---|
| SET | (Degrees) | (Degrees) | (Degrees) | (Degrees) | Slip | Reverse-slip |
| 1 | 10 | −10 | 0 | 22 | Yes | Yes |
| 2 | 10 | −8 | 0 | 22 | Yes | Yes |
| 3 | 10 | −6 | 0 | 22 | No | No |
| 4 | 10 | −6 | 0 | 22 | No | Yes |
| 5 | 8 | −6 | 0 | 12 | No | Yes |
| 6 | 8 | −6 | −10 | 22 | Yes | Yes |
| 7 | 10 | −6 | −6 | 22 | No | Yes |
| 8 | 10 | −6 | −4 | 22 | No | No |
| 9 | 10 | −6 | −5 | 22 | No | Yes |
| 10 | 10 | −6 | +8 | 22 | No | Yes |
| 11 | 10 | −6 | +7 | 22 | No | No |
| 12 | 10 | −6 | +7 | 12 | No | No |

Test Conclusions
1. For a given spring, changing the cam track angle has little effect on the performance of the jar opener. With a low (12 degree) cam track the jaw closing force is reduced.
2. The tooth alpha angle should be greater than 10-degrees.
3. The tooth beta angle should be zero to minus 6 degrees, to prevent closure/cap axial (expulsion) slippage.
4. The tooth gamma angle should be between minus 4 and plus 7 degrees.
   i.e. The inclination of the tooth from the jaw plate, (the gamma angle) being held to the range of minus 4 degrees to plus 7 degrees, with the tooth ‘relief’ angle alpha 10 degrees or greater, and the tooth ‘cone’ angle beta is in the range 6 degrees to zero degrees, there is little or no tendency for the closure/cap to be forced downwardly out of the jaws, and the grip of the teeth is satisfactory.

1. A jar opener, to immobilize the closure/cap of a sealed container and facilitate removal by a user of said closure/cap from said container; said opener having a fixed body portion; a closure/cap gripping device with a rotatable face plate; at least three jaw guides located in mutually converging relation on said face plate; at least three gripper jaws movably mounted in respective ones of said jaw guides; each said gripper jaw having an inclined protruding gripper tooth; each said tooth having a contact face for contacting side portions of said closure/cap; said opener having a synchronizing device for selectively moving said gripper jaws along said jaw guides in mutually synchronized displaced relation relative to said closure/cap, to bring said at least three gripper teeth into contacting relation with the side of said closure cap; said gripper teeth having an inner contact face to contact said closure/cap side; said contact face having a leading edge to make gripping contact with said closure/cap side, and a trailing edge in relieved relation from said closure/cap side, whereby in use, rotation of said closure/cap by a user in a first direction away from said leading edge permits freewheeling rotation of said closure cap in non-gripping relation past said trailing edge, and rotation in a second, reversed direction brings said teeth leading edges into gripping, immobilizing relation with said closure/cap, to facilitate removal of said closure/cap by said user.

2. The jar opener as set forth in claim 1, wherein said synchronizing device includes a control arm secured to said face plate, for rotational control thereof; a spring connecting said face plate with said fixed body portion to rotate said face plate and displace said gripper jaws inwardly; said gripper jaws each having a cam follower portion extending therefrom; and a cam plate having a plurality of cam track recesses to receive said cam follower portions in entered relation with said track recesses; whereby rotation of said control arm extends said jaws in opening relation, to permit insertion of said closure cap in entered relation between said jaws, and release of said control arm enables said spring to move said jaws into contact with said closure/cap.

3. The jar opener as set forth in claim 2, said gripper teeth each having an inwardly protruding toe portion, in use to extend beneath the lower edge of said closure/cap when said teeth are in contacting relation with said closure/cap, to secure said closure cap to said gripper device during removal of said container from said closure/cap.

4. The jar opener as set forth in claim 2, wherein said teeth are reversely inclined upon said jaws, in use to form a slightly conical entry for said closure/cap upon insertion between said teeth.

5. The jar opener as set forth in claim 1, wherein said gripper teeth contact face trailing edges have an angle of relief of at least 10-degrees from said leading edges; said teeth have a cone angle of at least minus six degrees; said teeth being upset at an angle in the range of 86 to 97 degrees from said gripper jaws; and said synchronizing device having three inwardly spiraling cam tracks, each connected in controlling relation with a respective said gripper jaw by way of a cam track follower pin; said cam tracks being inwardly inclined from the tangential, whereby rotational displacement of said cam tracks will produce displacement of said gripper jaws from gripping a small closure cap of 1¾ inch diameter to gripping a large closure cap of 3 5/16 inch diameter.

6. The jar opener as set forth in claim 1; a control arm extending from said face plate in rotational position controlling relation therewith; and first latch means connecting said control arm with said opener fixed body portion for selective control of displacement of said arm relative to said fixed body portion, whereby contact of said gripper teeth with said closure/cap side is controlled by operation of said first latch means.

7. The jar opener as set forth in claim 6, wherein said first latch means is operable to a first position in immobilizing relation with said arm, and wherein said first latch means is operable to a second position in displacement controlling relation with said arm, to apply increased closing force to said gripper jaws and to said gripper teeth.

8. The jar opener as set forth in claim 1; a control arm extending from said face plate in rotational position controlling relation therewith, to position said gripping device; and second latch means connecting said opener fixed body portion with said closure/cap gripping device, whereby in use, actuation of said control arm in an opening direction moves said gripper jaws in wider, mutually spaced relation; and said second latch means secures said closure/cap gripping device and said jaws in said wider spaced relation.

9. The jar opener as set forth in claim 2; having second latch means connecting said opener fixed body portion with said closure/cap gripping device, and latch release means projecting from said gripping device and located between said teeth, whereby in use, actuation of said control arm in an opening direction moves said gripper jaws in wider, mutually spaced relation; and said second latch means secures said closure/cap gripping device and said jaws in said wider spaced relation; and insertion of a closure/cap between said teeth actuates said latch release means, to disable said second latch means and enable said spring to move said jaws into contact with said closure/cap.

10. The jar opener as set forth in claim 2, wherein said synchronizing device has at least one shock absorber to cushion potentially damaging impacts between stationary parts of said jar opener and parts thereof moving freely under the full impetus of said spring.

11. The jar opener as set forth in claim 10, wherein said at least one shock absorber comprises stiff fibrous inserts located at end portions of said cam track recesses, to be impacted by said cam follower portions at the end of their travel in said recesses.

12. The jar opener as set forth in claim 2, wherein the gripping force of said jaws on said closure/cap is increased with increase in the stiffness of said spring.

13. The jar opener as set forth in claim 12, wherein the gripping force exerted by said jaws on said closure/cap increases with decrease in the angle of inward inclination of said cam tracks from the tangential.

14. The jar opener as set forth in claim 1, wherein the angle of relief of said blade trailing edge from being at right angles to the blade face, the alpha angle, is at least ten degrees; the angle of coning of the blade from the zero-cone setting, the beta angle, is in the range zero to minus six degrees; and the deviance angle of blade inclination from being normal to the jaw, the gamma angle, is in the range from minus four to plus seven degrees, whereby within said range of blade angular values said teeth grip said closure/cap on opening rotation of said container relative to said closure/cap, and said teeth do not grip said closure/cap on reversed, freewheel rotation of said container relative to said closure/cap.
